(19) United States
(12) Patent Application Publication
(10) Pub. No.: US 2023/0291430 A1
(43) Pub. Date: Sep. 14, 2023

(54) screen protector applicator for electronic equipment

(71) Applicant: Qidong Liang, Lianjiang (CN)

(72) Inventor: Hua Huang, Foshan (CN)

(21) Appl. No.: 17/838,453

(22) Filed: Jun. 13, 2022

(30) Foreign Application Priority Data
Mar. 9, 2022 (CN) 202210222182.1

(51) Int. Cl. H04B 1/3888; H04M 1/04

(52) U.S. Cl. CPC H04B 1/3888; H04M 1/04

(57) ABSTRACT

A screen protector applicator for electronic equipment, which includes a positioning die, an adhesive parts and a flexible pulling parts. The positioning die includes a bottom panel and a few of side panels, which form a positioning cavity for positioning a screen protector and the electronic equipment. The adhesive parts is fixed a first end of the bottom panel and a top surface of the adhesive parts is provided with an adhesive layer for sticking an end of the screen protector. The flexible pulling parts is fixed on the second end of the bottom panel. A top surface of the flexible pulling parts is provided with the other adhesive layer for sticking the other end of the screen protector, one end of the flexible pulling parts extends out of the positioning cavity. Using the screen protector applicator for electronic equipment, not only simple operation, but also no demand for film techniques, and after apply the screen protector, the screen protector and the screen is highly consistence, not form bubbles, high quality of applying the screen protector.

### FIELD OF THE INVENTION

The present invention relates to screen protector applicator technical field, more particularly, to a screen protector applicator for electronic equipment.

### BACKGROUND OF THE INVENTION

Electronic devices such as mobile phones and tablets are becoming more and more widely used. In using, the screens of the electronic devices are easily scratched, thereby affecting their use, and when they are fell down the ground, the screens are easily broken. In order to avoid the phenomenon, a user generally puts a screen protector on the screen.

However, in most cases, applying screen protectors are proceeded by manually tearing off the outer protective layer of screen protectors, then apply the screen protectors. However, as the most original means of applying screen protectors, the quality of applying screen protectors totally depends on the proficiency of the worker, and the screen protectors is usually not properly attached and easy to stick crooked. Applying screen protectors in the prior art has the deficiencies of difficult in control, low success rate, producing bubbles or not properly attached etc., which seriously affect the effect and the pasting efficiency of applying screen protectors.

### SUMMARY OF THE INVENTION

The object of the present invention is to provide a screen protector applicator for electronic equipment to solve the deficiencies that applying screen protectors manually is easily forms bubble and is easy to stick crooked.

In order to achieve the above object, the present invention provides the screen protector applicator for electronic equipment, which includes a positioning die, an adhesive parts and a flexible pulling parts. The positioning die includes a bottom panel and a few of side panels, which form a positioning cavity for positioning a screen protector and the electronic equipment. The adhesive parts is fixed a first end of the bottom panel and a top surface of the adhesive parts is provided with an adhesive layer for sticking an end of the screen protector. The flexible pulling parts is fixed on the second end of the bottom panel. A top surface of the flexible pulling parts is provided with the other adhesive layer for sticking the other end of the screen protector, one end of the flexible pulling parts extends out of the positioning cavity.

Further, the bottom panel is also provided with a positioning step near to the side panels, an inner surface of the positioning step contacts the edge of the screen protector.

Further, a top surface and a bottom surface of the flexible pulling parts are provided with an adhesive layer respectively, used for adhesive the second end of the bottom panel and the screen protector.

Further, a first cavity and a second cavity are respectively provided at both ends of the bottom panel. The first cavity is used for arranging the adhesive parts, the second cavity is an open structure, used for arranging the flexible pulling parts. The top surface of the adhesive parts and the top surface of the flexible pulling parts is higher than the bottom panel.

Further, the top surface of the adhesive parts is leveled with that of the flexible pulling parts, or the top surface of the adhesive parts is higher than that of the flexible pulling parts.

Further, the flexible pulling parts is made of an elastic glue with an adhesive layer.

Further, the flexible pulling parts is made of a battery tape or easy adhesive strip with some adhesive.

Further, the positioning die is also provided with a through hole through the bottom panel.

The above one or more technical schemes of the screen protector applicator for electronic equipment provided by the embodiment of the present invention have at least the following technical effects:
Before applying the screen protector, the screen protector is positioned in the positioning cavity by sticking with the adhesive parts and the flexible pulling parts, then tear off a releasing film on the screen protector.
Wipe the appearance of the electronic equipment clean and make the screen of the electronic equipment face up, the positioning die is covered on the electronic equipment so that the electronic equipment is positioned in the positioning cavity and the screen protector 400 contacts with the screen of the electronic equipment. Press the end of the positioning die, then pull the flexible pulling parts outward, because the top surface of the flexible pulling parts is provided with the other adhesive layer, under the function of the adhesive force of the other adhesive layer, the flexible pulling parts, which is pulled outwards, will slowly detach from the screen protector 400 and the bottom panel. thereby the screen protector gradually attached to the screen of the electronic equipment from one end away from the to the other end, thereby expelling the air between the screen protector and the screen so that the screen protector is tightly fitted to the screen of the electronic equipment, The screen protector and the electronic equipment are positioned by the positioning cavity which can ensure the positional accuracy of the screen protector on the screen.
Using the screen protector applicator for electronic equipment, not only simple operation, but also no demand for film techniques, and after apply the screen protector, the screen protector and the screen is highly consistence, not form bubbles, high quality of applying the screen protector.

### BRIEF DESCRIPTION OF THE DRAWINGS

In order to more clearly illustrate the technical schemes in the embodiments in the present invention, the drawings needed in the embodiments or the prior technical description are briefly introduced below. Obviously, the drawings described below are only some embodiments in the present invention, and for those skilled in the art, additional drawings may be obtained according to the drawings below without creative work.

FIG. 1 is a perspective view of the screen protector applicator for electronic equipment according to an embodiment in the present invention;

FIG. 2 is the other perspective view of the screen protector applicator for electronic equipment according to an embodiment in the present invention;

FIG. 3 is an explosive perspective view of the screen protector applicator for electronic equipment according to an embodiment in the present invention;

FIG. 4 is a perspective view of the position die of the screen protector applicator for electronic equipment according to an embodiment in the present invention;

FIG. 5 is another perspective view of the screen protector applicator for electronic equipment according to an embodiment in the present invention;

FIG. 6 is another perspective view of the screen protector applicator for electronic equipment according to an embodiment in the present invention.

### DETAILED DESCRIPTION OF ILLUSTRATED EMBODIMENTS

In order to make the invention purpose, the technical scheme and the technical effect more clearly be understood, the invention is further explained in combination with the concrete embodiment below. It should be understood that the specific embodiments described herein are only used to interpret the invention and are not used to limit the invention.

In the description of the embodiments of the present invention, it should be understood that the directional indications involved in the embodiments, such as the “upper”, “lower”, “left”, “right”, “front”, “rear”, “internal” and “external”, indicating orientation or location relationship, are based on the orientation or position relationship showed in the figures. These directional indications are only for describing the embodiments in the present invention and simplifying the description, rather than indicating or implying that the device or the element must be constructed and operated in a specified azimuth, which cannot be understood as a limitation of the present invention.

Further, the terms “first”, and “second” are used only for description purposes, and cannot be understood as indicating or implying relative importance or implicitly indicating the number of technical features indicated. Thus, features defining “first” and “second” may expressly or implicitly include one or more of the features. In the description of the embodiments of the present invention, the “plurality of” means two or more unless otherwise specifically limits.

In the embodiments of the invention, unless otherwise clearly specified and defined, the terms, “installed”, “connected”, “or” fixed” should be generally understood, for example, a fixed connection, or a removable connection, a mechanical connection or an electrical connection, or an directly connection or an indirectly connection through an intermediate media, or a connection within two elements or the interaction of two elements. For those of ordinary skilled in the art, the specific meaning of the above terms in the embodiment of the present invention may be understood under specific circumstances.

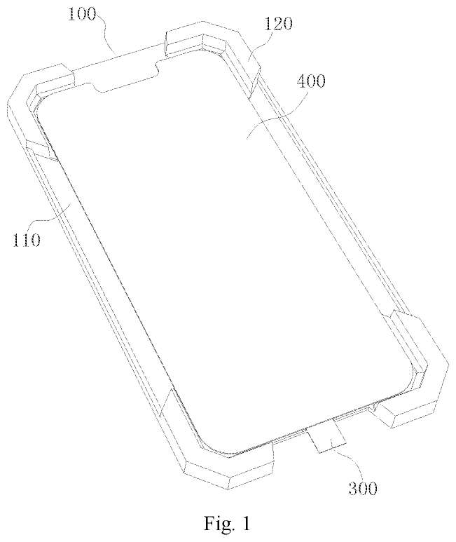

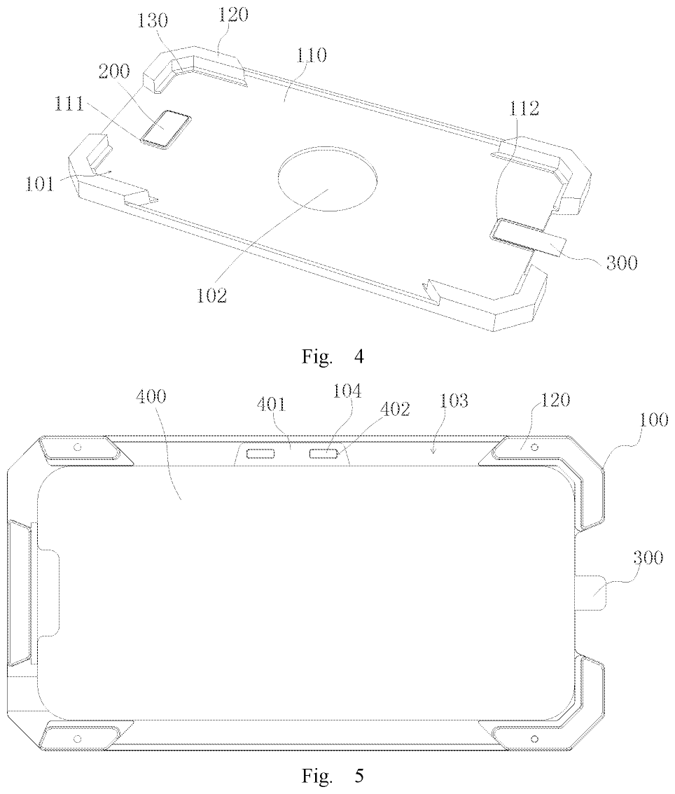

Referring to FIG. 1-4, a screen protector applicator for electronic equipment, using for applying the screen protector on screens of the electronic equipment, includes a positioning die 100, an adhesive parts 200 and a flexible pulling parts 300. The positioning die 100 includes a bottom panel 110 and a few of side panels 120, which form a positioning cavity 101 for positioning a screen protector 400 and the electronic equipment. The adhesive parts 200 is fixed a first end of the bottom surface 100 and a top surface of the adhesive parts 200 is provided with an adhesive layer for sticking an end of the screen protector 400 covered with a releasing film. The flexible pulling parts 300 is fixed on the second end of the bottom surface 100. A top surface of the flexible pulling parts 300 is provided with the other adhesive layer for sticking the other end of the screen protector 400, one end of the flexible pulling parts 300 extends out of the positioning cavity 101.

Before applying the screen protector 400, the screen protector 400 is positioned in the positioning cavity 101 by sticking with the adhesive parts 200 and the flexible pulling parts 300, then tear off the releasing film on the screen protector 400.

Wipe the appearance of the electronic equipment clean and make the screen of the electronic equipment face up, the positioning die 100 is covered on the electronic equipment so that the electronic equipment is positioned in the positioning cavity 101 and the screen protector 400 contacts with the screen of the electronic equipment. Press the end of the positioning die 100, then pull the flexible pulling parts 300 outward, because the top surface of the flexible pulling parts 300 is provided with the other adhesive layer, under the function of the adhesive force of the other adhesive layer, the flexible pulling parts 300, which is pulled outwards, will slowly detach from the screen protector 400 and the bottom panel 110. thereby the screen protector 400 gradually attached to the screen of the electronic equipment from one end away from the to the other end, thereby expelling the air between the screen protector 400 and the screen so that the screen protector 400 is tightly fitted to the screen of the electronic equipment, The screen protector 400 and the electronic equipment are positioned by the positioning cavity 101 which can ensure the positional accuracy of the screen protector 400 on the screen.

Using the screen protector applicator for electronic equipment, not only simple operation, but also no demand for film techniques, and after apply the screen protector, the screen protector and the screen is highly consistence, not form bubbles, high quality of applying the screen protector.

Further, referring to FIG. 1-4, the screen protector 400 can attached in the positioning cavity 101 during producing process. Specifically, the producing process, the adhesive parts 200 is attached to or forms on the bottom panel 110, the flexible pulling parts 300 is attached to the other end of the screen protector 400, or the flexible pulling parts 300 is attached to a second end of the bottom surface 100, and the end of the flexible pulling parts 300 extends out of the positioning cavity 101, then the screen protector 400 is attached to the adhesive parts 200. When applying the screen protector 400, it is only necessary to tear off the other releasing film on the screen protector 400 to realize the application of the screen protector 400. The application of the screen protector 400 is more simple. And the screen protector 400 is positioned in the screen protector applicator when it is produced, thereby ensuring the positioning accuracy of the screen protector 400, and improving the quality of applying the screen protector 400.

Further, referring to FIG. 1-4, when it is required to apply the screen protector 400, the user attaches the screen protector 400 into the positioning cavity 101. The user can choose the screen protector 400 with qualities and different performance. Specifically, the adhesive parts 200 can be arranged in the bottom panel 110 when it is produced, it also can be attached to the bottom panel 110 before applying by the users. Whether the screen protector 400 is arranged in the positioning cavity 101 during production, or the screen protector 400 is arranged in the positioning cavity 101 by the user, it is only different in production form, no substantial difference, both are in the protection range of the present invention.

Further, referring to FIG. 1-4, the bottom panel 110 is also provided with a positioning step 130 near to the side panels 120. In the embodiment, when the screen protector 400 is attached to the positioning cavity 101, an inner surface of the positioning step 130 contacts the edge of the screen protector 400, thereby positioning the screen protector 400 in the positioning cavity 101.

Further, in anther embodiment for increasing the positioning effect of the screen protector 400, referring to FIG. 5, a periphery edge of the releasing film extends at least an extending part 401, the extending part 401 is provided with at least two positioning holes 402, a breach 103 is provided between two of the side panels 120, used for containing the extending part 401. At least two positioning columns 104 extend upward from the breach 103 and pass through the two positioning holes 402, thereby positioning the screen protector 400.

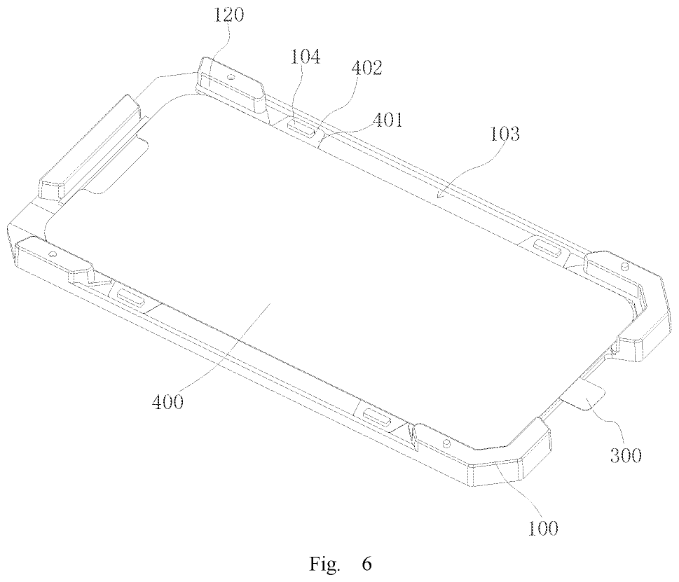

Further, referring to FIG. 6, it is provided with another embodiment about the positioning holes 402 and the positioning columns 104. The periphery edge of the releasing film extend at two extending parts 401, which can be arranged on the same side edge or different side edges of the releasing film. Each of the is provided with at least two positioning holes 402. Two of the breaches 103, corresponding to each of the two extending parts 401 are provided between two of the side panels 120. At least two positioning columns 104 extend upward from the breach 103 and pass through the two positioning holes 402, thereby positioning the screen protector 400 with higher accuracy, further improving the accuracy of the screen protector 400.

Further, referring to FIG. 1-4, a top surface and a bottom surface of the flexible pulling parts 300 are provided with an adhesive layer respectively, used for adhesive the other end of the bottom panel 110 and the screen protector 400. In the embodiment, the other end of the screen protector 400 is fixed by the flexible pulling parts 300 so as to increase a stability of the screen protector 400 in the position cavity 101 and increase a resistance to pull the flexible pulling parts 300 outwards, thereby extending time of pulling the flexible pulling parts 300 so that the screen protector 400 has enough time to apply and expel the air between the screen protector 400 and the screen of the electronic equipment, which improves the quality of applying the screen protector 400.

Further, referring to FIG. 1-4, a first cavity 111 and a second cavity 112 are respectively provided at both ends of the bottom panel 110. The first cavity 111 is used for arranging the adhesive parts 200, the second cavity 112 is an open structure, used for arranging the flexible pulling parts 300. One end of the flexible pulling parts 300 can extends out of the second cavity 112. The top surface of the adhesive parts 200 and the top surface of the flexible pulling parts 300 is higher than the bottom panel 110. In the embodiment, when the screen protector 400 is arranged in the positioning cavity 101, it can be adhesive in the positioning cavity 101 by the adhesive parts 200 and the flexible pulling parts 300. And when press the positioning die 100, the adhesive parts 200 extrudes the screen protector 400 to attach to the screen, thereby the screen protector 400 gradually discharge the air from the extrusion area and attach to the screen, further avoid the bubble formation after apply the screen protector 400.

Further, referring to FIG. 1-4, the top surface of the adhesive parts 200 is leveled with that of the flexible pulling parts 300, or the top surface of the adhesive parts 200 is higher than that of the flexible pulling parts 300. In the embodiment, when the positioning die 100 covers the electrical equipment, and press the end, closed to the adhesive parts 200, of the positioning die 100, only the pressed part of the screen protector 400 is attached to the screen, the left part is not attached to the screen, therefor, when pulling the flexible pulling parts 300, the screen protector 400 can gradually discharge the air and attach to the screen.

Further, referring to FIG. 1-4, the flexible pulling parts 300 is made of an elastic glue with an adhesive layer. In the embodiment, the flexible pulling parts 300 is pulled, it produces elastic deformation and gradually grows, increasing the contact area of the adhesive layer and the screen protector 400. When pulling to a certain degree, the flexible pulling parts 300 departs from the screen protector 400.

Further, referring to FIG. 1-4, the flexible pulling parts 300 is made of a battery tape or easy adhesive strip with some adhesive. After being pulled, no adhesive material remains on the screen protector 400, which ensures the quality of applying the screen protector 400. The battery tape or the easy adhesive strip are commonly used materials in the market and belong to the existing materials, so their specific parameters are not detailed in this embodiment.

Further, the positioning die 100 is also provided with a through hole 102 through the bottom panel 110. In the embodiment, the screen protector 400 is attached to the screen, it can be pressed through the through hole 102 so that the pressed part of the screen protector 400 is better fits the screen, and when pulls the flexible pulling parts 300, press the screen protector 400 so that one end of the screen protector 400 suffers the pressure force, the other end of the screen protector 400 suffers a pulling force, thereby the screen protector 400 can better fit the screen. After applying the screen protector 400, the screen protector 400 can be pressed through the through hole 102 to separate the positioning die 100 and the screen protector 400.

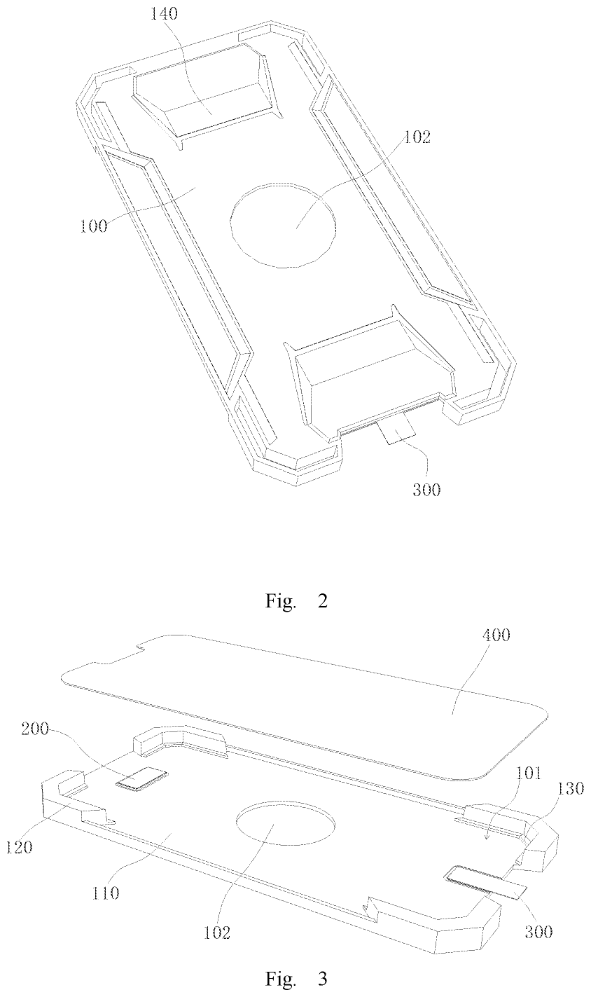

Further, referring to FIG. 2, in order to cover the positioning die 100 on the electrical equipment, the bottom surface of the positioning die 100 is provided with two exprotruding handheld portions 140 at opposited two ends. Each of the exprotruding handheld portions 140 has four inclined slopes. The users can press the inclined slopes with two hands so that the positioning die 100 can be pressed on the electrical equipment.

A method of applying the screen protector for electronic equipment, referring to FIG. 1-FIG. 4, the adhesive parts 200 adhesives the screen protector 400 in the positioning cavity 101, then tears off the releasing film on the surface, facing to the screen, of the screen protector 400, covers the positioning die 100 on the electrical equipment, so that the screen protector 400 attaches to the screen. Press the positioning die 100 or do it through the through hole 102, and pull gradually the flexible pulling parts 300, so that the air between the screen protector 400 and the screen are gradually discharged, and the screen protector 400 attaches on the screen.

The other method of applying the screen protector for electronic equipment, referring to FIG. 1-FIG. 4, the adhesive parts 200 and the flexible pulling parts 300 are respectively adhesive both ends of the bottom surface 100. The screen protector 400 adhesives the adhesive parts 200 and the flexible pulling parts 300. Tear off the releasing film on the surface, facing to the screen, of the screen protector 400 tears off, cover the positioning die 100 on the electrical equipment, press the positioning die 100 or do it through the through hole 102, and pull gradually the flexible pulling parts 300, so that the air between the screen protector 400 and the screen are gradually discharged, and the screen protector 400 attaches on the screen.

The above is only a better embodiment of the invention and is not used to restrict the invention, and any modification, equivalent replacement and improvement made within the spirit and principles of the invention shall be included in the scope of protection of the invention.

What is claimed is:

1. A screen protector applicator for electronic equipment, wherein comprising a positioning die, an adhesive parts and a flexible pulling parts; said positioning die includes a bottom panel and a few of side panels, which form a positioning cavity for positioning a screen protector and said electronic equipment; said adhesive parts is fixed a first end of said bottom panel and a top surface of said adhesive parts is provided with an adhesive layer for sticking an end of said screen protector; said flexible pulling parts is fixed on said second end of said bottom panel. A top surface of said flexible pulling parts is provided with the other adhesive layer for sticking said other end of said screen protector, one end of said flexible pulling parts extends out of said positioning cavity

2. The screen protector applicator for electronic equipment according to claim 1, wherein said bottom panel is also provided with a positioning step near to said side panels, an inner surface of said positioning step contacts an edge of said screen protector.

3. The screen protector applicator for electronic equipment according to claim 1, wherein a top surface and a bottom surface of said flexible pulling parts are provided with an adhesive layer respectively, used for adhesive said second end of said bottom panel and said screen protector.

4. The screen protector applicator for electronic equipment according to claim 2, wherein a top surface and a bottom surface of said flexible pulling parts are provided with an adhesive layer respectively, used for adhesive said second end of said bottom panel and said screen protector.

5. The screen protector applicator for electronic equipment according to claim 1, wherein a first cavity and a second cavity are respectively provided at both ends of said bottom panel; said first cavity is used for arranging said adhesive parts, said second cavity is an open structure, used for arranging said flexible pulling parts; said top surface of said adhesive parts and said top surface of said flexible pulling parts is higher than said bottom panel.

6. The screen protector applicator for electronic equipment according to claim 2, wherein a first cavity and a second cavity are respectively provided at both ends of said bottom panel; said first cavity is used for arranging said adhesive parts, said second cavity is an open structure, used for arranging said flexible pulling parts; said top surface of said adhesive parts and said top surface of said flexible pulling parts is higher than said bottom panel.

7. The screen protector applicator for electronic equipment according to claim 1, wherein said top surface of said adhesive parts is leveled with that of said flexible pulling parts, or said top surface of said adhesive parts is higher than that of said flexible pulling parts.

8. The screen protector applicator for electronic equipment according to claim 2, wherein said top surface of said adhesive parts is leveled with that of said flexible pulling parts, or said top surface of said adhesive parts is higher than that of said flexible pulling parts.

9. The screen protector applicator for electronic equipment according to claim 1, wherein said flexible pulling parts is made of an elastic glue with an adhesive layer.

10. The screen protector applicator for electronic equipment according to claim 9, wherein said flexible pulling parts is made of a battery tape or easy adhesive strip with some adhesive.

11. The screen protector applicator for electronic equipment according to claim 1, wherein said positioning die is also provided with a through hole through said bottom panel.

12. The screen protector applicator for electronic equipment according to claim 1, wherein said screen protector has a release film, a periphery edge of said releasing film extends at least an extending part, said extending part is provided with at least two positioning holes, a breach is provided between two of said side panels, used for containing said extending part; at least two positioning columns extend upward from said breach and pass through said two positioning holes, thereby positioning said screen protector.

13. The screen protector applicator for electronic equipment according to claim 1, wherein said screen protector has a release film, a periphery edge of said releasing film extend at two extending parts, each of said two extending parts is provided with at least two positioning holes; two of said breaches are provided between two of said side panels for containing said two extending parts; at least two positioning columns extend upward from said breach and pass through said two positioning holes, thereby positioning the screen protector.

14. The screen protector applicator for electronic equipment according to claim 1, wherein the adhesive parts adhesives the screen protector in the positioning cavity, then tears off the releasing film on the surface, facing to the screen, of the screen protector, covers the positioning die on the electrical equipment, so that the screen protector attaches to the screen; Press the positioning die or do it through the through hole, and pull gradually the flexible pulling parts, so that the air between the screen protector and the screen are gradually discharged, and the screen protector attaches on the screen.

15. The screen protector applicator for electronic equipment according to claim 1, wherein the adhesive parts and the flexible pulling parts are respectively adhesive both ends of the bottom surface; the screen protector adhesives the adhesive parts and the flexible pulling parts; tear off the releasing film on the surface, facing to the screen, of the screen protector tears off, cover the positioning die on the electrical equipment, press the positioning die or do it through the through hole, and pull gradually the flexible pulling parts, so that the air between the screen protector and the screen are gradually discharged, and the screen protector attaches on the screen.
